(19) United States
(12) Patent Application Publication
(10) Pub. No.: US 2017/0072552 A1
(43) Pub. Date: Mar. 16, 2017

(54) TOOL HOLDER

(71) Applicant: Hilti Aktiengesellschaft, Schaan (LI)

(72) Inventors: Udo HAUPTMANN, Landsberg (DE); Horst STROISSNIGG, Puergen (DE); Ralf MEIXNER, Germaringen (DE)

(73) Assignee: Hilti Aktiengesellschaft, Schaan (LI)

(21) Appl. No.: 15/120,441

(22) PCT Filed: Feb. 10, 2015
(86) PCT No.: PCT/EP2015/052731

§ 371 Date: Aug. 19, 2016

(30) Foreign Application Priority Data
Feb. 20, 2014 (EP) 14155949.2

(51) Int. Cl. B25D 17/08; B25D 16/00

(52) U.S. Cl. CPC B25D 17/088; B25D 16/00; B25D 2217/0038; B25D 2250/051

(57) ABSTRACT

A tool holder for a rotating and chiseling portable power tool is disclosed. A hollow spindle surrounds, coaxially with a working axis, a receiving space for receiving a tool. The hollow spindle has at least one cutout in the radial direction. An insert is inserted into the cutout in the radial direction. The insert has a rib that protrudes into the receiving space in the radial direction. A channel is arranged within the cutout and extends along the working axis. The channel is open into the receiving space and is bounded by the insert and an inner face of the cutout.

This application claims the priority of International Application No. PCT/EP2015/052731, filed Feb. 10, 2015, and European Patent Document No. 14155949.2, filed Feb. 20, 2014, the disclosures of which are expressly incorporated by reference herein.

### BACKGROUND AND SUMMARY OF THE INVENTION

The present invention relates to a tool holder for a rotating and chiseling portable power tool, in particular a combination hammer.

U.S. Pat. No. 7,338,051 describes a tool holder for a combination hammer. The tool holder has a tubular base structure in whose interior the drill bit is received along its axis. Locking elements engage in the interior and secure the drill bit against falling out. Additionally, the tool holder has ribs which engage in corresponding grooves of the drill bit in order to transmit a torque from the tool holder to the drill bit. The ribs are made of a hard metal and are inserted into the base structure as inserts. The ribs are fastened in overlapping boreholes in the base structure. A fixing can be accomplished via adhesion, press-fitting, soldering, or welding. The use of ribs made of hard metal produces a very high abrasion of the drill bits. End pieces of the ribs cant in the longitudinal grooves of the drill bits and knock them out.

The tool holder according to the invention is provided for a rotating and chiseling portable power tool, for example a combination hammer. A hollow spindle surrounds, coaxially with a working axis, a receiving space for receiving a tool. The spindle has at least one cutout in the radial direction. An insert is inserted into the cutout in a radial direction. The insert has a rib that protrudes into the receiving space in the radial direction. A channel is arranged within the cutout and extends along the working axis. The channel is open into the receiving space and is bounded by the insert and an inner face of the cutout. The insert is preferably soldered in the cutout. The respective contact faces of the insert and the cutout should be completely wetted with the solder, or else the bonding zone will be weakened. This can be achieved simply through a surplus of solder. The channel according to the invention indeed decreases the contact faces and thereby weakens the strength of the bond, however, the channel functions as a reliable barrier for the liquid solder. The soldering can occur without a surplus.

One design provides that the rib features lateral faces inclined in relation to the vertical direction, which partially protrude into the cutout and are separated from the spindle by the channel within the cutout. The part of the lateral faces protruding into the receiving space can feature a height which amounts to between 50% and 75% of the total height of the rib. The cross-section of the insert, which increases monotonically in a radial direction up to the bonding zone, is suitable for introducing the high mechanical shearing stresses of the rib into the spindle.

The following description explains the invention using exemplary embodiments and figures.

### BRIEF DESCRIPTION OF THE DRAWINGS

FIG. 1 illustrates a combination hammer;

FIG. 2 illustrates a tool holder;

FIG. 3 illustrates the tool holder in the cross-section of the plane III-III;

FIG. 4 is a top view of an insert;

FIG. 5 is a cutout for the insert in the plane V-V; and

FIG. 6 illustrates the insert in the cutout.

### DETAILED DESCRIPTION OF THE DRAWINGS

Unless noted otherwise, identical or functionally equivalent elements are indicated by the same reference numbers in the figures.

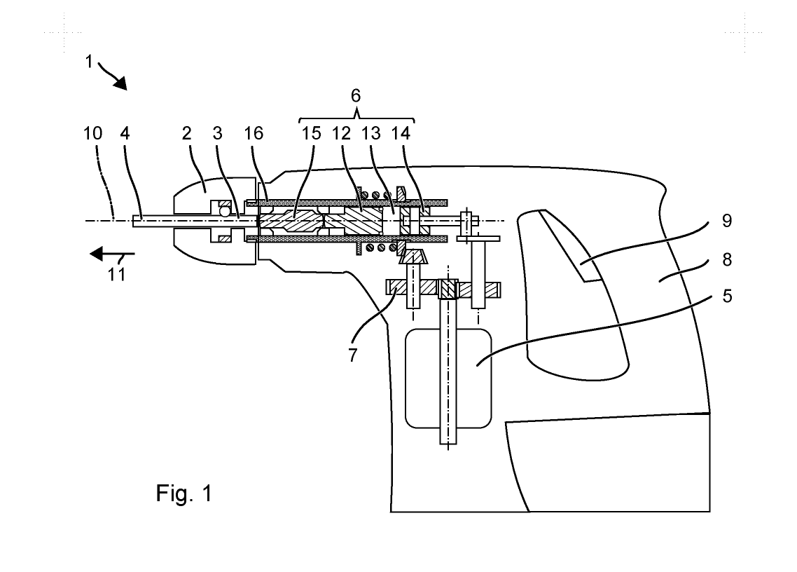

FIG. 1 shows a schematic example of a chiseling portable power tool in the form of a combination hammer 1. The combination hammer 1 has a tool holder 2, into which a shaft end 3 of a tool, for example a hammer drill 4, can be inserted. A primary drive of the combination hammer 1 forms a motor 5 which drives a striking mechanism 6 and an output shaft 7. A user can guide the combination hammer 1 using a handgrip 8 and can put the combination hammer 1 into operation using a system switch 9. In the operating mode, the combination hammer 1 continuously rotates the hammer drive 4 around a working axis 10 and can thereby drive the hammer drill 4 in the impact direction 11 along the working axis 10 into a substrate. The striking mechanism 6 is preferably a motor-driven pneumatic striking mechanism 6. A striker 12 is coupled via an air spring 13 to an excitation piston 14, which is moved back and forth by the motor 5 along a working axis 10. The striker 12 strikes the shaft end 3 either directly or indirectly through a plunger 15.

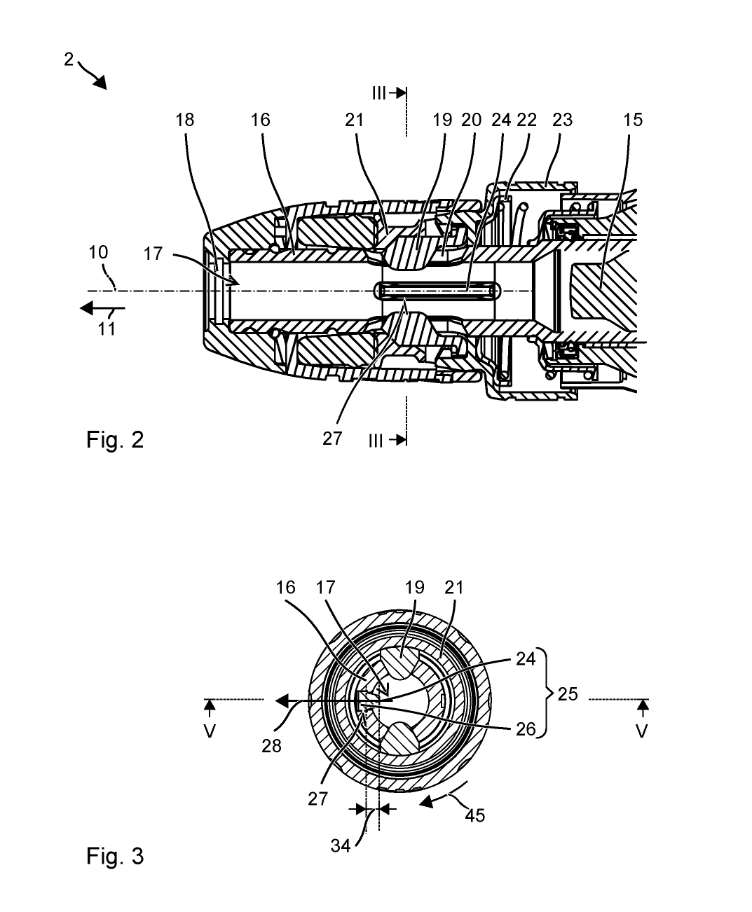

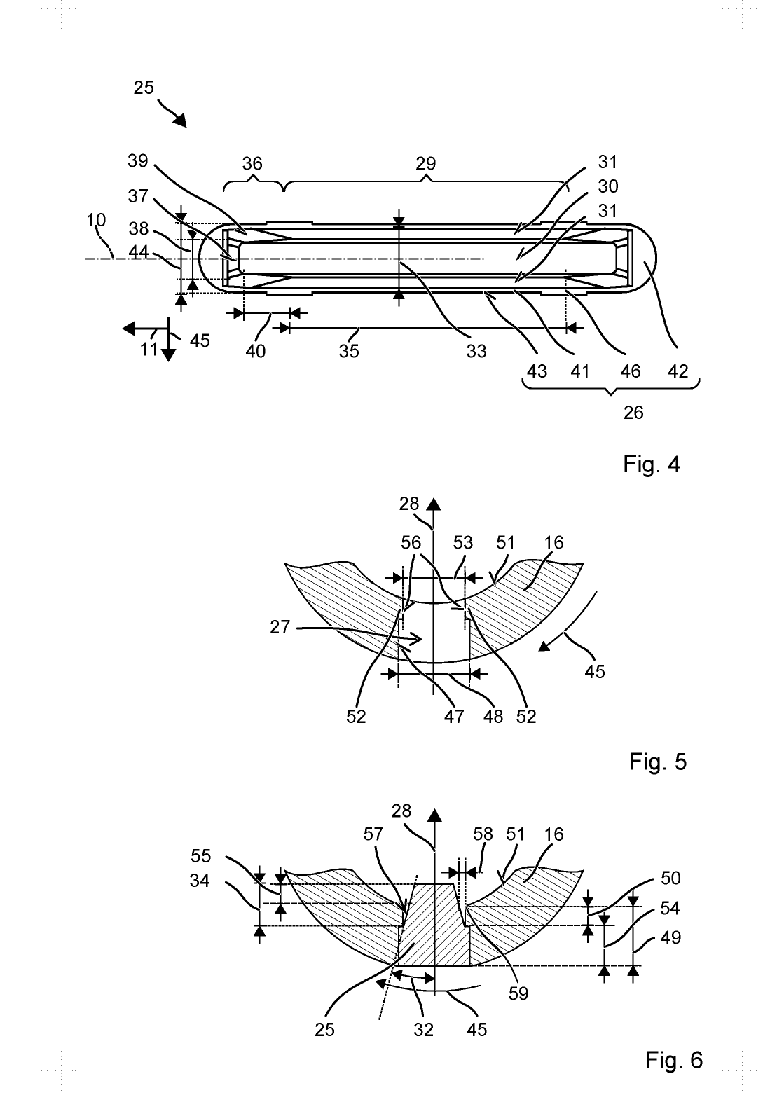

The tool holder 2 is depicted in detail in FIG. 2 in a longitudinal section and in FIG. 3 in a cross-section. FIG. 6 shows a detailed section in the plane V-V. The tool holder 2 has a hollow spindle 16 (base structure) driven by the output shaft 7 with a receiving space 17 for the tool 4. The hammer drill 4 can be inserted into the receiving space 17 through an opening 18 on the output side in the insertion direction (counter to the impact direction 11). The receiving space 17 is preferably complimentary to the shaft end 3, for example cylindrically formed.

A detachable locking of the hammer drive 4 that is equipped with locking grooves in the receiving space 17 occurs via barrier bodies, in this case with latches 19. The latches 19 are inserted into slots 20 in a wall of the hollow spindle 16. A radial restraint of the latches 19 occurs through a locking ring 21, at which the latches 19 partially protrude into the receiving space 17 radially from the interior adjacently. The part of the latches 19 protruding into the receiving space 17 can engage with the locking groove of the tool 4. A spring-loaded slider 22 holds the latches 19 within the locking ring 21, i.e., axially overlapping with the locking ring 21. Upon insertion of the hammer drill 4, the latches 19 are pushed against the spring-loaded slider 22 and become disengaged from the locking ring 21. The latches 19 can give way radially and uncover the receiving space 17. The latches 19 can be pushed against the spring-loaded slider 22 by an actuating sleeve 23, whereby the radial restraint of the latches 19 is lifted and the hammer drill 4 can be removed.

The rotational motion of the hollow spindle 16 is transmitted to the hammer drill 4 via the ribs 24 protruding into the receiving space 17. The exemplary embodiment of the tool holder 2 has a rib 24. Alternative tool holders 2, in particular for hammer drills with large diameters, can feature two or more ribs 24. Along the working axis 10, the rib 24 is at the height of the slots 20 for the latches 19.

The rib 24 is the part of the insert 25 protruding into the receiving space 17. The insert 25 has the rib 24 and a socket 26. The hollow spindle 16 has a cutout 27 for each rib 24, into which the socket 26 is inserted in a radial direction 28. The cutout 27 is complimentary to the socket 26. The socket 26 is permanently fixed in the cutout 27 through soldering. The entire insert 25 is preferably monolithic, i.e., made of one material and continuous with no bonding zones. The insert 25 can be manufactured of a tool steel. The hollow spindle 16 is made of another material, for example manufactured of a low-alloy steel.

The rib 24 has a main section 29. The main section 29 substantially transmits the entire torque to the combination hammer 1. The exposed exterior faces of the main section 29, in particular a top face 30 and two lateral faces 31, are parallel to the working axis 10. The exterior faces form the boundaries of a trapezoidal cross-section, which is constant over the entire length of the main section 29 along the working axis 10. The top face 30 is perpendicular to a radial direction 28 (vertical direction). The lateral faces 31 preferably border the opposing longitudinal edges of the top face 30. The lateral faces 31 are inclined at an angle 32 relative to the vertical direction 28 and are preferably inclined towards one another between 20 degrees and 40 degrees. The rib 24 is thus preferably wider at its bottom face, i.e., on the socket 26, than at the top face 30. An average width 33 of the rib 24 is approximately equal to the height 34 of the rib 24, i.e., differing by less than 20%. A length 35 of the main section 29 is at least three times the height 34. The rib 24 must be sufficiently long for the transmission of the torque to the drill bit 4.

The rib 24 has a rear section 36, which is arranged behind the main section 29 in the impact direction 11. The rear section 36 has a front face 37, which points in the impact direction 11. The front face 37 is preferably trapezoidal. The perpendicular of the front fact 37 lies in a plane spanned by the working axis 10 and the vertical direction 28. The exemplary front face 37 is not perpendicular to the working axis 10 but rather inclined between 70 degrees and 80 degrees. The front face 37 is preferably flat. The front face 37 is somewhat narrower than the main section 29, i.e., smaller than the trapezoidal cross-section. A width 38 of the front face 37 at the socket 26 lies between 80% and 90% of the width 33 of the cross-section at the socket 26.

Two opposing run-in faces 39 laterally border the front face 37. The run-in faces 39 join the front face 37 to the lateral faces 31. The flat run-in faces 39 are somewhat inclined in relation to the lateral faces 31, preferably between 2 degrees and 10 degrees. The run-in faces 39 preferably extend from the socket 26 to the top face 30. A length 40 of the run-in faces 39 corresponds approximately to the distance between the two run-in faces 39, i.e., the width 33 of the rib 24.

The exemplary socket 26 consists substantially of a longitudinal rectangular midsection 41. The longitudinal ends of the midsection 41 are closed by half-cylindrical end pieces 42. The lateral faces 43 of the midsection 41 are preferably parallel to each other. The lateral faces 43 extend parallel to the lateral faces 31 of the rib 24 and are arranged parallel to the working axis 10 in the spindle 16. The lateral faces 43 of the socket are preferably longer than the rib 24 or at least longer than the lateral faces 31 of the rib 24. The end pieces 42 project over the rib 24 along the working axis 10. The width 44 of the socket 26, i.e., the distance between the lateral faces 43, is greater than the width 33 of the rib 24. The socket 26 projects over the rib 24 in the circumferential direction 45. The socket 26 can feature projections 46 protruding laterally from the lateral face 43 which increase the width 44 of the socket 26. The projections 46 are oriented correspondingly in the circumferential direction 45 around the working axis 10. The dimension of the projections 46 along the lateral face 43, i.e., along the working axis 10, is less than 10% of the length of the lateral faces 43.

The cutout 27 in the spindle 16 has two inner faces 47 that extend in a parallel manner (FIG. 5). The distance 48 between the inner faces 47 is equal to the width 44 of the socket 26. A length of the inner faces 47 is equal to the length of the lateral faces 43 of the socket 26. Half-cylindrical ends close the cutout 27 along the working axis 10 and are complimentary to the end pieces 42 of the socket 26. The socket 26 is trapped in the cutout 27 along the working axis 10 and in the circumferential direction 45 in a form-fitting manner. A solder is introduced between the inner faces 47 and the lateral faces 43 of the socket 26 in order to fix the insert 25 in the vertical direction 28.

The cutout 27 penetrates the hollow spindle 16 along the vertical direction 28. The height of the cutout 27 is thus equal to the wall thickness 49 of the hollow spindle 16. The cutout 27 tapers in the direction 28 of the working axis 10 to such an extent that the socket 26 is kept at a distance 50 from the guide face 51. The exemplary cutout 27 has two opposing steps 52 which border the parallel inner faces 47 in the direction 28 of the working axis 10. The distance 53 between the steps 52 is less than the width 44 of the socket 26 and simultaneously equal to or greater than the width 33 of the rib 24. The socket 26 rests against the steps 52 in the direction 28 of the working axis 10. The socket 26 is correspondingly separated from the cylindrical inner face 51 of the receiving space 17 (guide face). The socket 26 has for example a height 54 which is less than the wall thickness 49 and is completely received in the cutout 27.

The rib 24 partially protrudes into the cutout 27 with its inclined front faces 31. The part of the rib 24 protruding into the receiving space 17 has a height 55 which amounts to between 50% and 80% of the total height 34 of the rib 24. The part resting in the cutout 27 has a height 50 which corresponds to the distance of the socket 26 from the guide face 51 of the receiving space 17.

The steps 52 have inner faces 56 which face each other and which extend to the guide face 51 along the vertical direction 28. The exemplary inner faces 47 are parallel to the vertical direction 28. Two channels 57 are formed between the inclined lateral faces 31 of the ribs 24 and the inner faces 56 of the steps 52. The channels 57 have a triangular cross-section and extend parallel to the rib 24, i.e., parallel to the working axis 10. The length of the channels 57 corresponds preferably to the length 35 of the rib 24. The channel 57 is open to the receiving space 17. The opening width 58 is in a range between 0.3 mm (millimeters) and 0.6 mm. The opening width 58 is the distance of the edge 59 from the cutout 27 at the guide face 51 to the lateral face 31 of the rib 24. The height or depth 50 of the channel 57 is equal to the distance from the socket 26 to the guide face 51. The depth 50 is at least equal to the opening width 58. The channel 57 forms an air gap between the insert 25 and the spindle 16.

The cylindrical end pieces 42 of the socket 26 are preferably recessed in the cutout 27 vis-à-vis the guide face 51 counter to the vertical direction 28. The vertical distance is preferably equal to the depth 50 of the channels 57.

The inner faces 56 of the steps 52 can be inclined towards each other in such a way that their distance 53 increases in the direction 28 of the working axis 10. The channels 57 can correspondingly feature an opening angle which is greater than the inclination 32 of the lateral faces 43 of the rib 24. The opening width 58 is in a range between 0.3 mm and 0.6 mm. The depth 50 is at least equal to the opening width 58.

The lateral faces 31 of the rib 24 can be configured more steeply within the cutout 27, i.e., with a lower inclination relative to the vertical direction 28, than outside of the cutout 27. The cross-section of the channels 57 can feature an approximately rectangular cross-section. The opening width 58 is in a range between 0.3 mm and 0.6 mm. The depth 50 is at least equal to the opening width 58.

The hollow spindle 16 can be manufactured for example of a tubular blank. The tubular blank can be expanded coldly on the desired inner profile. Subsequently, the inner and exterior faces are machined. Additionally, the slots 20 for the latches 19 and the cutout 27 for the insert 25 are formed by machining, for example with a milling head. Bearing sections can be trimmed and polished to a desired diameter.

The steel of the tubular blank is preferably a low-alloy steel, for example 16MnCr5. A carbon content is preferably less than 0.4% by weight and greater than 0.1% by weight. The steel is low-alloyed; the entire admixture of alloy elements is less than 5% by weight. Chrome can have the highest percentage in this context, for example between 1.0 and 2.2% by weight. The steel can also be unalloyed. In this case, the carbon content is also less than 0.4% by weight.

The insert 25 is preferably manufactured without machining. The insert 25 can be forged for example from a steel blank. Forming can occur through a die in which the blank is inserted. The die can be made for example of multiple parts and has a complimentary shape to the insert 25, i.e., to the rib 24 with the socket 26. The blank is forged at a temperature between 950 Celsius and 1150 Celsius. In doing so, the AC3 temperature of the steel is exceeded, whereby austenite is formed. After forming, the insert 25 cools to room temperature, preferably by air. Alternatively, the insert 25 can be manufactured using a precision casting process.

The blank for the insert 25 is a tool steel, for example X155CrVMo12-1. The carbon content is greater than 0.8% by weight, preferably less than 2.2% by weight. The blank is highly alloyed, and the percentage of all the alloy elements is greater than 7% by weight.

The insert 25 is inserted into the cutout 27 of the hollow spindle 16. A solder material, preferably a solder containing copper, is introduced between the lateral walls of the socket 26 and the inner faces 47 of the cutout 27. The insert 25 is soldered onto the hollow spindle 16, for example in a soldering oven furnace, preferably at a temperature in a range of 1030 Celsius and 1070 Celsius. The air gap formed by the channels 57 between the insert 25 and the spindle 16 prevents the creeping of the liquid solder up to the guide face 51 of the receiving space 17. The soldering process lasts between 20 minutes and 60 minutes. During soldering, the steels of the hollow spindle 16 and the insert 25 are heated above their recrystallization temperature. The tool steel thereby loses hardness. After soldering, the composite of the hollow spindle 16 and the insert 25 cools, preferably by air or in another gas atmosphere.

The composite is then heat-treated in a step that follows immediately. The composite is heated to a temperature between 800 Celsius and 950 Celsius. The temperature can be raised in two or more steps in order to minimize thermo-mechanical stress in the composite. The composite is kept at the temperature for 30 minutes to 2 hours. The temperature lies significantly below a temperature which is suitable for the hardening of tool steel. For the exemplary tool steel X155CrVMo12-1, the temperature given is 1160 Celsius to 1190 Celsius. This temperature is also atypical for the threefold repeated heat-treatments of tool steel which occur with a maximum temperature between 400 Celsius and 600 Celsius, in order to maintain the typical hardness and load-bearing capacity of a tool steel.

The heat-treatment takes place in an atmosphere containing carbon, for example in a gas carburizing furnace. The carbon level is raised through the admixture of, for example, methanol and propane. A C-level regulation preferably keeps the carbon level constant during the heat-treatment. The carbon level is selected such that the hollow spindle 16 is carburized. The C-level for the selected steel can be taken from tables or simulations or determined in few trials. A measurement of the C-level can be determined in the known manner indirectly via the partial pressure of oxygen. Further, the C-level is controlled such that the tool steel of the insert 25 is not carburized. The C-level could lie between 0.7 and 0.75, for example. The carbon in the insert 25 can be reduced or retained.

The heat-treatment is concluded through rapid quenching, for example in oil. The composite is hardened. The heat-treatment is expediently followed by a one-time annealing at a low temperature between 180 Celsius and 210 Celsius, in order to reduce inner stress.

In one design, the quenching of the composite to room temperature can be followed by a cooling to −60 Celsius to −120 Celsius. The deep freezing can promote the hardening of the composite. The one-time annealing follows the deep freezing.

1-8. (canceled)

9. A tool holder for a rotating and chiseling portable power tool, comprising:
a hollow spindle, wherein the hollow spindle surrounds, coaxially with a working axis, a receiving space for receiving a tool and wherein the hollow spindle includes a cutout in a radial direction;
an insert, wherein the insert is disposed in the cutout and wherein the cutout includes a rib that protrudes into the receiving space in the radial direction; and
a channel, wherein the channel is disposed within the cutout, extends along the working axis, opens into the receiving space, and is bounded by the insert and an inner face of the cutout.

10. The tool holder according to claim 9, wherein the rib includes lateral faces which are inclined in relation to the radial direction, partially protrude into the cutout, and are separated from the hollow spindle by the channel.

11. The tool holder according to claim 10, wherein the lateral faces have a part which protrudes into the receiving space and wherein the part has a height that is between 50% and 80% of a total height of the rib.

12. The tool holder according to claim 9, wherein the channel has an opening width of at least 0.3 mm.

13. The tool holder according to claim 9, wherein a length of the channel corresponds to a length of the rib.

14. The tool holder according to claim 9, wherein the insert includes a socket with lateral faces which extend along the working axis and which are fixed against inner faces of the cutout by a solder.

15. The tool holder according to claim 14, wherein the socket is separated from the receiving space by the channel.

16. A portable power tool, comprising:
a tool holder according to claim 9;
a motor; and
a pneumatic striking mechanism, wherein the pneumatic striking mechanism includes an exciter that is forcibly drivable by the motor along the working axis, a striker that is moveable along the working axis, and an air spring that is disposed between the exciter and the striker and that couples a motion of the exciter to the striker.
